(19) United States
(12) Patent Application Publication
(10) Pub. No.: US 2006/0001967 A1
(43) Pub. Date: Jan. 5, 2006

(54) Wide-field three dimensional imaging system

(75) Inventors: Pol Techakumpuch, Nontaburi (TH); Daniel Dick, Honolulu, HI (US)

Correspondence Address: NIXON & VANDERHYE, PC, 901 NORTH GLEBE ROAD, 11TH FLOOR, ARLINGTON, VA, 22203, US

(73) Assignee: Pol Techakumpuch, Nontaburi (TH)

(21) Appl. No.: 10/880,648

(22) Filed: Jul. 1, 2004

(51) Int. Cl. G02B 27/22

(52) U.S. Cl. 359/464

(57) ABSTRACT

A three dimensional imaging system comprises a first screen having a plurality of transparent openings arranged in a uniform pattern extending in both the horizontal and vertical directions, and a recording medium spaced apart from the first screen for recording an array of images of an object at an instant in time, each image of the array of images reflecting a unique viewpoint of the object from a corresponding one of the plurality of transparent openings. A second screen is arranged between the first screen and the recording medium. The second screen has a plurality of transparent openings in a uniform pattern extending in both the horizontal and vertical directions to prevent adjacent images of the array from overlapping.

### BACKGROUND OF THE INVENTION

1. Technical Field

The present invention relates in general to the field of wide-field three-dimensional imaging.

2. Description of Related Art

A regular photographic image gives the viewer a two-dimensional picture of a single viewing angle. This two-dimensional picture of a single viewing angle is similar to what one eye of a human viewer sees at one instant in time. Viewing such pictures results in seeing a “flat” image without a sense of depth because both eyes of the human viewer sees exactly the same image.

When a human viewer looks at a real object, the human's two eyes do not see the same image. The right eye sees a little more of the right side of the object and also a little more around to the right back side of the object than the left eye. The same principle applies to the left eye which sees a little more of the left side than the right eye does.

Current technologies which allow viewers to see three-dimensional images normally accomplish this task by taking two photographic images of the same object at a slightly different angle of view and supplying each image to each eye separately. The result is a picture with a sense of depth. However, this setup still gives a single viewing angle for a pair of eyes. The human viewer will see a “deep” picture as if he/she is at a fixed position. Moving to a different position while viewing the same setup will not give a different view.

Another photographic technology capable of providing both depth and variable viewing angle is holography. Holography is a method which records a continuous range of viewing angles on a single piece of photographic film. A hologram provides the viewer images with both depth and variable angle of view. If the viewer moves around while viewing the same piece of film, the viewer will see the object in three-dimensions from a continuously changing angle as if the real object is actually present behind the film.

Since a hologram can only be made through the use of laser, its disadvantages include the requirement that a picture can only be taken in a studio and that the picture is monochromatic. The object must be lit with a laser only and therefore requires a studio with special equipment. Since a laser contains only a single color, the result is a recording of light or dark areas and hence a “black and white” image.

### BRIEF DESCRIPTION

A three dimensional image recording system comprises: a first screen having a plurality of transparent openings arranged in a uniform pattern extending in both the horizontal and vertical directions, and a recording medium spaced apart from the first screen, the recording medium recording an array of images of an object at an instant in time, each image of the array of images reflecting a unique viewpoint of the object from a corresponding one of the plurality of transparent openings. The system may further comprise a second screen arranged between the first screen and the recording medium, the second screen having a plurality of transparent openings arranged in a uniform pattern extending in both the horizontal and vertical directions. Each of the images may be projected to the recording medium from a corresponding one of the transparent openings of the first screen, and the transparent openings of the first screen may be aligned with the transparent openings of the second screen to prevent adjacent images from overlapping. The system may record an array of images necessary for a three dimensional reproduction of the object over a substantially continuous range of viewing angles in both the vertical and horizontal axes. The first screen and the recording medium may be connected together as a single unit, or alternatively, the first screen and the recording medium may be separately replaceable. The recording medium may be a photographic film or an electronic photo-sensitive device. Each of the transparent openings of the first screen may be formed by a pinhole or by a lens. The array of images may be recorded in real time so that a subsequent array of images of the object may also be recorded in the recording medium in real time.

A three dimensional image displaying system comprises (i) an image projecting means for projection of an array of images of an object at an instant in time, the image projecting means having a plurality of transparent openings arranged in a uniform pattern both in the horizontal and vertical directions and (ii) a recording means spaced apart from the image projecting means, the recording means records an array of images of an object taken at an instant in time, each image of the array of images reflecting a unique viewpoint of the object from a corresponding one of the plurality of transparent openings. The system may further comprise a blocking means arranged between the image projecting means and the recording means, the blocking means having a plurality of transparent openings arranged in a uniform pattern extending in both the horizontal and vertical directions for allowing respective images to be projected from the recording means exclusively through corresponding openings of the image projecting means. Adjacent projected images of the array may be prevented from overlapping by an opaque area surrounding each transparent opening. The system may render a three dimensional reproduction of the object over a substantially continuous range of viewing angles in both the vertical and horizontal axes. The system may further comprise an illumination means for projecting each of the recorded images back through image projecting means. At least the image projecting means and the recording means are connected together as a single unit, or alternatively, are separately replaceable. The array of images may be projected from the recording means in real time so that a subsequent array of images of the object may also be projected from the recording means in real time.

### BRIEF DESCRIPTION OF THE DRAWINGS

FIG. 1 is a partial side view of an exemplary three dimensional imaging system;

FIG. 2 is a partial front view of a screen in the system illustrated in FIG. 1 having a plurality of transparent openings for projecting images;

FIG. 3 is partial front view of a screen in the system illustrated in FIG. 1 for preventing overlap of adjacent images;

FIG. 4 is a diagram depicting an operation of the exemplary system illustrated in FIG. 1;

FIG. 5 is a diagram showing details of a portion of FIG. 4;

FIG. 6 is a diagram depicting a viewing operation of the exemplary system illustrated in FIG. 1; and

FIG. 7 is a diagram depicting exemplary images recorded by the exemplary system illustrated in FIG. 1.

### DETAILED DESCRIPTION

If two cameras are arranged side by side; the two cameras can capture two images necessary for the recreation of a “deep” image. Adding another camera (i.e., a third camera) to the right of the original right camera will add another view from a “neighbor” position. When the viewer shifts his/her position to the right, he/she will view a new image for his/her right eye from the “neighbor” (i.e., third) camera while his/her left eye will view the image from the original right camera as its new image. Thus the “deep” effect is maintained while the viewing angle is shifted to the right. The viewer will now see from a new angle to the right of his/her original position. Further addition of cameras on both the right and left sides adds to a wider range of viewing angles.

Applying the same principle on the vertical axis produces a vertical range of viewing angles that the viewer gains by moving up or down. A one-eyed person can compensate for his lack of depth information by moving to a neighboring position to gain more information of his subject. As another example, adding two cameras above the original right and left cameras will add two additional views from above neighbor positions When the viewer shifts his/her position upwards, he/she will view a new image for his/her right eye from the above right neighbor camera and a new image for his/her left eye from the above left neighbor camera. Thus, the “deep” effect is maintained while the viewing angle is shifted upwards. The viewer will now see a new angle above his/her original position. Further addition of cameras both above and below the original cameras adds to a wider range of viewing angles in the vertical direction.

Such set-up as described above may be used to produce a billboard-size image, which is “deep” and has wide viewing positions and true color. However, it may be too cumbersome and too expensive for personal use. This problem can be resolved however by downsizing each camera to a minute scale.

Providing a miniature camera with lenses may be difficult. For example, a very small lens may be difficult to produce and focusing mechanism of such scale will have to be very precise. In one exemplary embodiment, pinhole cameras may thus be used to solve all of these problems. In particular, in one exemplary embodiment, a fine matrix extending in horizontal and vertical directions of pinholes can be printed on a sheet of transparent material. Such pinhole cameras may require no focusing.

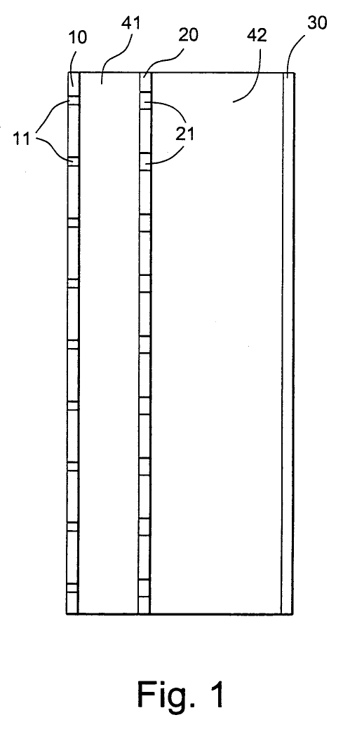

FIG. 1 illustrates a portion of an exemplary three-dimensional imaging system. The three-dimensional imaging system includes screen 10, screen 20 and recording medium 30. Screens 10 and 20 are connected by intervening transparent layer 41. Screen 20 and recording medium 30 are connected by intervening transparent layer 42. Transparent sheets 41 and 42 may be formed by, for example, a clear glass or acrylic sheet.

Screen 10, transparent layer 41, screen 20, transparent layer 42 and recording medium 30 may be connected together as a single unit to ease production of the three-dimensional imaging system and to ease handling of its components. Alternatively, one or more of the sheets forming screens 10, 20, transparent layers 41, 42 and recording medium 30 may be formed by interchangeable sheets that may slide out to be replaced separately. Physical parameters such as the respective widths between screens 10 and 20 and/or screen 20 and recording medium 30 may thus be altered through the interchangeable sheets.

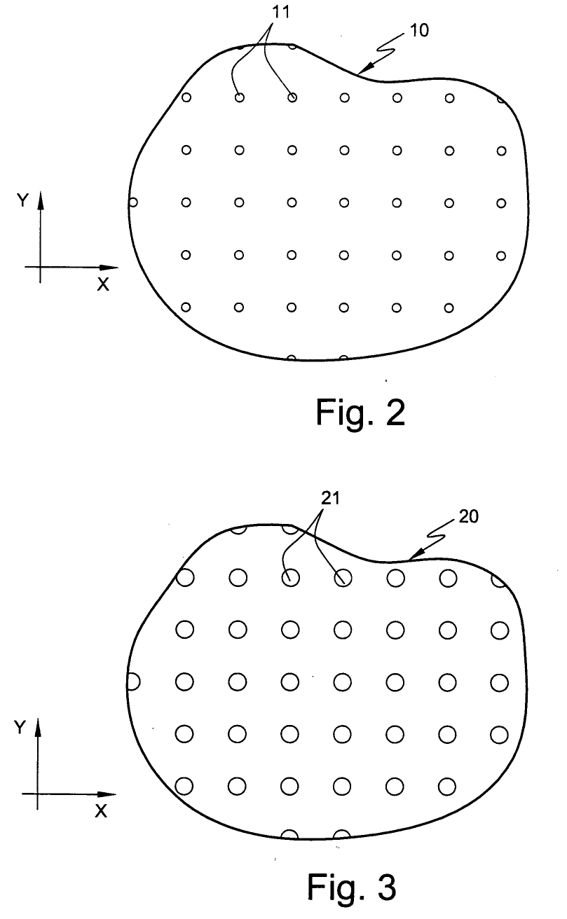

FIG. 2 illustrates a partial front view of screen 10. Screen 10 includes a plurality of transparent openings 11. Transparent openings 11 are arranged in a uniform pattern extending in both the vertical (Y) and horizontal (X) directions. Each of these transparent openings 11 may be formed by a lens. Alternatively, the transparent openings 11 may be formed by printing a matrix of colorless (transparent) circles with a black background onto a transparent sheet of rigid or flexible plastic. That is, screen 10 may be formed by a sheet of transparent material printed with a black background on most of the transparent sheet except that small round openings are left at regular intervals both vertically and horizontally to form “pinhole” openings. While “pinhole” openings must let light through to record respective camera images, they are not necessarily physical holes piercing through the sheet forming screen 10, although physically piercing such holes through the sheet may be another exemplary way of forming “pinholes”.

Each transparent opening 11 of screen 10 forms a basis for a single pinhole camera positioned adjacent to other single pinhole cameras in a uniform pattern. As a particular example, screen 10 may have fifty openings per inch, each opening having a radius of about 0.041 mm.

FIG. 3 illustrates a partial front view of screen 20. Like screen 10, screen 20 includes a plurality of transparent openings 21 in a uniform pattern which extends in both the vertical and horizontal axes. Like openings 11, transparent openings 21 may be formed by lenses or by printing an opaque material on the background of a transparent sheet with small round pinhole openings being left colorless (transparent) at regular intervals both vertically and horizontally. Openings 21 of screen 20 are aligned directly behind corresponding openings 11 in screen 10. Transparent openings 21 of screen 20 are larger than transparent openings 11 of screen 10. For example, the radius of each opening 21 may be 0.083 mm. However, there are no specific limitations on optimum radii for openings 11 and 21. The determining constraints are the grain (or pixel) size of recording medium 30 and the capability to produce fine openings 11 and 21 on screens 10 and 20, respectively. If a very fine grain film is available and very fine openings 11 and 21 can be printed, a resolution of a resulting image produced by the system for viewing may be high enough that the viewer will not notice the effect of the screens during viewing. However, if the pinholes are relatively large, the viewer will likely see that the image consists of “dots.” Each of openings 21 allows only a central portion of the projection from corresponding openings 11 passing through screen 10 to get through to recording medium 30 so that there is no overlap of neighboring images recorded by recording medium 30.

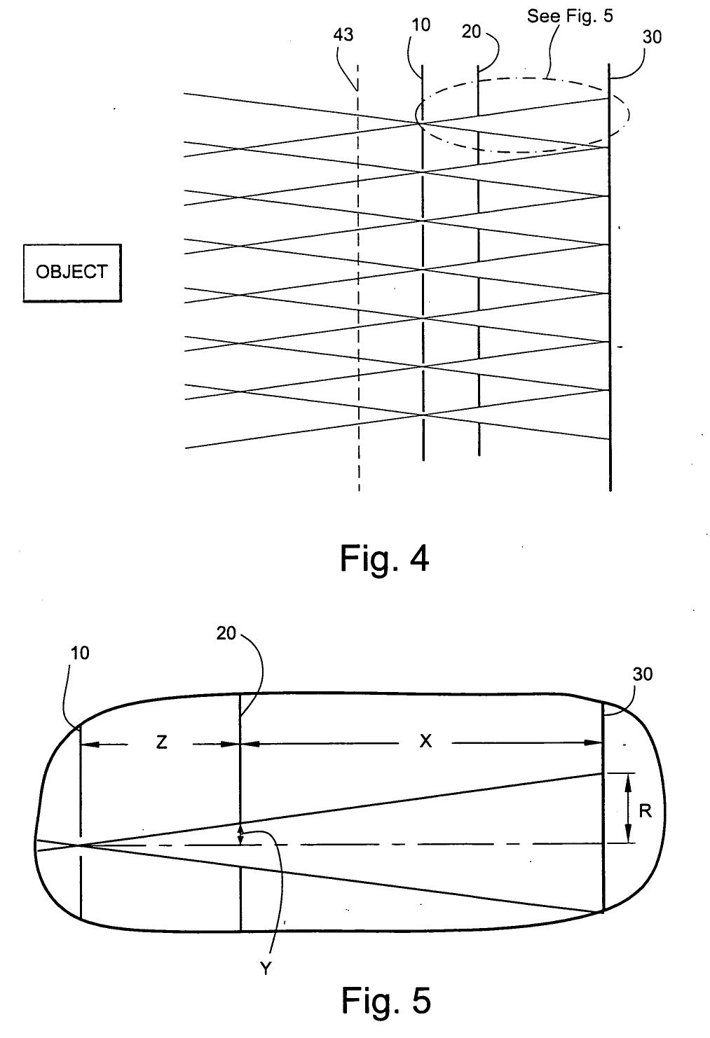

FIG. 4 is a diagram depicting recordation of a plurality of images of an object taken from unique viewpoints corresponding to the plurality of transparent openings 11 in screen 10. If recording medium 30 is formed by a photo-sensitive film, the three-dimensional imaging system will further include a shutter 43. Shutter 43 allows light exposure only when desired. Shutter 43 covers the entire area of the recording medium 30. Shutter 43 may be a mechanical shutter as found in film plane shutter cameras (i.e., single lens reflex camera's shutter). Alternatively, shutter 43 may be formed by a liquid crystal display (LCD) which is normally completely opaque and only turns transparent when the user of the three-dimensional imaging system presses the record button (not shown) to initiate light exposure and allow the 2-D array of images of the object to be taken from the slightly different viewpoints provided by the plurality of transparent openings 11. Shutter 43 is placed in front of screen 10, particularly if screens 10, 20 and recording medium 30 are incorporated together as a single unit. Alternatively, shutter 43 may be positioned behind screen 20, particularly if screens 10, 20 and/or recording medium 30 are separately removable or adjustable.

If the recording medium 30 is formed by an electronic device such as a CCD or another semiconductor photo-sensitive device, providing a separate shutter may be avoided as recording medium 30 can be exposed at all times with the images being recorded only when desired.

The sizing of transparent openings 11 on screen 10 and the spacing between openings 11 will influence the quality of the final image produced by the three-dimensional imaging system. Very small openings, though requiring brighter subjects or longer exposure time, will provide sharper images as long as the grain size of a photographic film recording medium (or pixel size of an electronic recording medium) can resolve the fine details of the projections originating from the openings. Placing openings 11 at large intervals apart dictates that a larger proportion of the recording medium is allocated for each pinhole projection, and thus larger magnification of the same image results which yields to a finer detail on the recording medium. However, larger amounts of spacing renders a courser final image during viewing as a border between openings is more apparent.

As a particular example, a spacing interval of fifty openings per inch for openings 11 may be selected. At this requirement, each opening will be about 0.5 mm apart. Therefore each minute image can be no larger than 0.5 mm in diameter or 0.25 mm in radius. As shown in FIGS. 4-5, a center line drawn through the top opening 11 of screen 10 perpendicular to screen 20 and recording medium 30 results in an imaginary right-angle triangle being developed whose base (labeled “R” in FIG. 5) on recording medium 30 is 0.25 mm. The radius of the top opening 21 in screen 20 is labeled “Y”. A distance between screens 10 and 20 is labeled “Z” and the distance between screen 20 and recording medium 30 is labeled “X”.

As illustrated in FIG. 5, trigonometry can be used to calculate the appropriate portion of the size of openings 21 in screen 20 and the appropriate position that screen 20 should be placed between screen 10 and recording medium 30. In particular, a trigonometric relationship for calculating sizes and positions is as follows: Y/R=Z/(X+Z). If R=0.25 mm and Z is chosen to be 1 mm (by positioning transparent layer 41 having a width of 1 mm between screens 10 and 20) and X is chosen to be 2 mm (by positioning another transparent layer 42 having a width of 2 mm between screen 20 and recording medium 30) then Y will be equal to 0.083 mm. The size of openings 11 must therefore be significantly smaller than the size of openings 21.

When shutter 43 is opened or made transparent (or a recording is made if the recording medium 30 is a CCD), exposure of the object in front of screen 10 will result in a plurality of images being taken from viewpoints corresponding to openings 11. Since the pattern of openings 11 extend in both the vertical and horizontal directions (i.e., each of openings 11 has a slightly different viewpoint to the object), an array of unique images is taken. The array has dimensions in both the vertical and horizontal directions. Each opening 11 in screen 10 projects its unique image unto recording medium 30 through corresponding openings 21 in screen 20. A smaller opening 11 in screen 10 will produce a sharper image on recording medium 30, but with less light falling unto recording medium 30. The farther the openings 11 are from the recording medium 30, the higher the magnification of the images. However, the cone (see FIGS. 4-5) of light behind the opening will be as wide as the cone corresponding to the light seen in front of it. An opening 21 in screen 20 is used to block the perimeter of each cone so that they do not overlap. That is, one purpose of screen 20 is that a size of each of its openings 21 allows only a central portion of the projections from a corresponding opening 11 to get through the recording medium 30 so that adjacent images do not overlap. A possible scenario where screen 20 is not needed is when the object stands alone in a dark environment at such a far distance that the images from each opening 11 do not overlap. If the object is moved toward the screen 10, the cones, and thus the images, will become bigger until they finally overlap with each other.

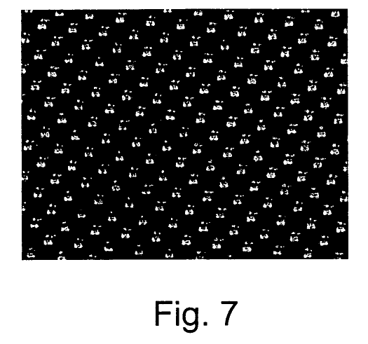

FIG. 7 illustrates a magnified portion of a photographic slide forming an exemplary recording medium 30 which includes a 2-D array of unique images of the same object taken at an instant in time. Each image of the object recorded in the recording medium 30 depicts a slightly different angle of viewpoint from the next. These unique images result because each opening 11 takes a picture of the same object at the same moment in time from a different viewpoint. The slightly different viewpoints allow for the three-dimensional imaging system to provide a substantially continuous range of viewing angles of an object in both the vertical and horizontal axes from a single recording.

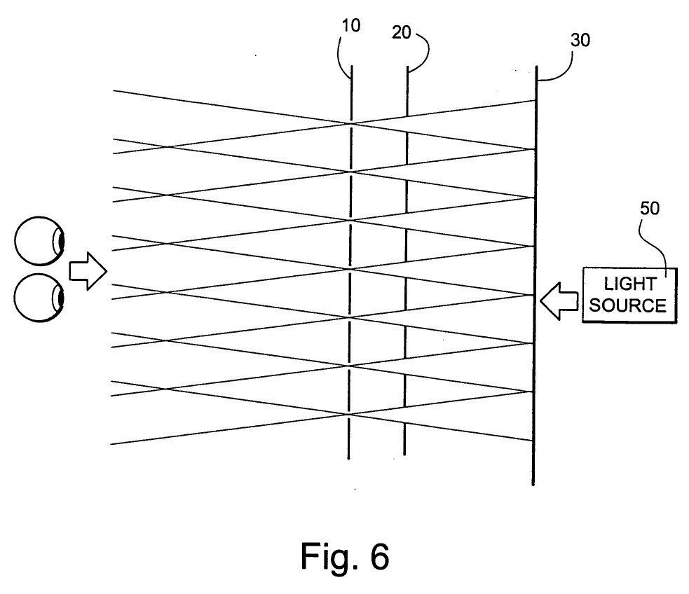

FIG. 6 is a diagram depicting a display operation of recorded images. The display operation involves providing a light or illumination source 50 behind recording medium 30, while a viewer is positioned in front of screen 10 and looks directly through screen 10 at a distance. In particular, if the screens 10, 20 and recording medium 30 are formed as a single unit, a viewer would view the images like one would view a slide. A uniform light source is positioned behind the recording medium 30 and the viewer looks through the screens 10, 20. If the screens 10, 20 and/or recording medium 30 are separately removable, the system can be re-assembled to its recording configuration, a light source positioned behind recording medium 30 and the viewer then views straight into the camera's screens 10, 20. An exposed piece of film serving as the recording medium 30 will display an image of the original object only when viewed through a set of screens 10, 20 with the same spacing (e.g., fifty openings per inch). However, a set of different screen separations (separations X and Z) provided with suitable sized openings 21 in screen 20 may provide a mirror cone projecting back out to the viewer showing the same scene with a narrower (but allowable) viewer movements horizontally or vertically before entering a cut-off point. The cut-off point is formed when there is a blackout or the neighboring image(s) can be seen through a current opening. If the cone is set to be very long and narrow, then the image resembles a normal two-dimensional picture. If separation distances X and Z are reduced, the view angle will be expanded and the depth of the image will-be exaggerated. The picture quality will change accordingly.

If the recording medium is an electronic medium, the light source 50 and the recording medium 30 are replaced with a CRT or LCD screen. Screens 10, 20 and distances Z and X must be recalculated to match the picture images projected on the screen at that magnification. For example, if the image array shown on the monitor is 5 mm apart, then screens A and B will have to have openings at 5 mm intervals and distances Z, X and Y must be recalculated accordingly. Compared to a photo-sensitive film serving as a recording medium 30, this type of system would yield larger magnification since pixel size on the displaying side is much larger than on the recording side.

The area of each minute image should cover several grains or pixels on the recording medium 30. The reason for this is that each minute image must contain information of the scene from several different angles so that when a viewer looks through the same opening from a different angle, he/she will see a different part of the scene. If each minute image consisted of only a single pixel, for example, the same image would be seen from every angle.

As described above, an array of images having a horizontal and vertical component is recorded on recording medium 30 to capture images of an object taken at a single instance. The three-dimensional imaging system allows the images to be recorded in real time without time-consuming processing before the next array of images can be recorded. If a plurality of image arrays are recorded quickly in succession, then the data necessary for a three-dimensional movie can be recorded and later viewed. The recording medium such as a film sheet at the back of the camera would essentially become film passing the imaging system at about 25 frames per second with the shutter operating synchronously. A small version of this 3-D movie system would look like a single lens reflex camera with the lens taken off and the four image-projecting layers placed just in front of its film and then attached to a motor drive. The display device would be a movie projector with the four layers instead of a lens. However, the viewer must face the projector and look directly into it. The electronic recording medium version is analogous to a digital still-picture camera that can record a movie clip. If the four layers are fixed during recording, they also may stay the same during playback.

In addition to personal use, the three-dimensional imaging system is also suitable for production of larger images of the same quality. For example, large projection systems such as an advertising billboard is possible. After the images are recorded as described above, the resulting image for view can be enlarged to a desired dimension which, when viewed through the screens enlarged to the same proportion, projects larger final images for the viewing audience. When viewed at a further distance, the border of the larger dots will become unnoticeable.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A three dimensional image recording system comprising:
a first screen having a plurality of transparent openings arranged in a uniform pattern both in the horizontal and vertical directions; and
a recording medium spaced apart from the first screen, the recording medium recording an array of images of an object at an instant in time, each image of the array of images reflecting a unique viewpoint of the object from a corresponding one of the plurality of transparent openings.

2. The system as in claim 1, further comprising a second screen arranged between the first screen and the recording medium, the second screen having a plurality of transparent openings arranged in a uniform pattern both extending in the horizontal and vertical directions.

3. The system as in claim 1, wherein each of the images is projected to the recording medium from a corresponding one of the transparent openings of the first screen, and the transparent openings of the first screen are aligned with the transparent openings of the second screen to prevent adjacent images from overlapping.

4. The system as in claim 1 wherein at least the first screen and the recording medium are connected together as a single unit.

5. The system as in claim 1 wherein the first screen and the recording medium are separately replaceable.

6. The system as in claim 1, wherein the recording medium is a photographic film.

7. The system as in claim 1, wherein the recording medium is an electronic photo-sensitive device.

8. The system as in claim 1, wherein each of the transparent openings of the first screen is formed by a pinhole.

9. The system as in claim 1, wherein each of the transparent openings of the first screen is formed by a lens.

10. The system as in claim 1, wherein the array of images is recorded in real time so that a subsequent array of images of the object can also be recorded in the recording medium in real time.

11. A three dimensional image displaying system comprising:
an image projecting means for projection of an array of images of an object at an instant in time, the image projecting means having a plurality of transparent openings arranged in a uniform pattern both in the horizontal and vertical directions; and
a recording means spaced apart from the image projecting means, the recording means records an illuminated display of an array of images of an object taken at an instant in time, each image of the array of images reflecting a unique viewpoint of the object from a corresponding one of the plurality of transparent openings.

12. The system as in claim 11, further comprising a blocking means arranged between the image projecting means and the recording means, the blocking means having a plurality of transparent openings arranged in a uniform pattern extending in both the horizontal and vertical directions for allowing each of the images to be projected from the recording means exclusively through its corresponding opening of the image projecting means.

13. The system as in claim 11, wherein the opaque area surrounding each transparent openings of the blocking means prevents projection of each of the images through adjacent openings from overlapping.

14. The system as in claim 11 wherein the system renders a three dimensional reproduction of the object over a substantially continuous range of viewing angles in both the vertical and horizontal axes.

15. The system as in claim 11, further comprising an illumination source for projecting each of the recorded images back through image projecting means.

16. The system as in claim 11 wherein at least the image projecting means and the recording means are connected together as a single unit.

17. The system as in claim 11 wherein the image projecting means and the recording means are separately replaceable.

18. The system as in claim 11, wherein the array of images is displayed in real time so that a subsequent array of images of the object can also be displayed in real time.

19. The system as in claim 1, wherein the array of images recorded in the recording medium is capable of providing a three-dimensional reproduction of the object over a substantially continuous range of viewing angles in both the vertical and horizontal axes.
